(19) United States
(12) Patent Application Publication
(10) Pub. No.: US 2005/0109973 A1
(43) Pub. Date: May 26, 2005

(54) Valve diaphragm

(76) Inventors: William H. Glime, Painesville, OH (US); Victor Rasanow, Eastlake, OH (US); Terrence J. Kolenc, Mentor, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/993,100

(22) Filed: Nov. 19, 2004

Related U.S. Application Data
(60) Provisional application No. 60/524,063, filed on Nov. 21, 2003.
(60) Provisional application No. 60/521,334, filed on Apr. 2, 2004.

(51) Int. Cl. F16K 1/00; F16K 15/00; E03B 1/00; E03C 1/00; F17D 1/00

(52) U.S. Cl. 251/331

(57) ABSTRACT

The invention is generally directed towards diaphragms and diaphragm valves with geometries that decrease stress and wear on diaphragms and increase the cycle life of diaphragms. Stresses and wear can be decreased by reducing the amount of diaphragm deflection needed to open and close a valve, or by reduce or eliminate contact between a diaphragm and other diaphragms or components.

### RELATED APPLICATIONS

This application claims the benefit of U.S. Provisional Applications Nos. 60/524063 filed on Nov. 21, 2003 and 60/521334 filed on Apr. 2, 2004, the entire disclosures of which are fully incorporated herein by reference.

### FIELD OF INVENTION

The present application is directed to diaphragms and diaphragm valves. More specifically, the application is directed to diaphragm valve configurations and methods of fabricating diaphragm valves which reduce wear and stress on diaphragms.

### BACKGROUND

Diaphragm valves are well known, such as those that are described in U.S. Pat. Nos. 6,092,550, 4,606,374, 5,131,627, and 6,189,861, the entire disclosures of which are fully incorporated herein by reference. FIG. 1A illustrates a conventional diaphragm valve A, wherein FIG. 1B is an enlarged illustration of the area B shown in FIG. 1A.

The valve A includes an inlet C and an outlet D formed in a valve body E. The inlet C is in fluid communication with an inlet flow passage F and the outlet D is in fluid communication with an outlet flow passage G. Inlet and outlet as used herein are for convenience as flow can be reversed in some applications through the valve A. Also formed in the valve body is a valve cavity or chamber H. The inlet flow passage F opens to the valve cavity H at a first orifice I and the outlet flow passage G opens to the valve cavity H at an orifice J. An annular valve seat K surrounds the first orifice I, and a circular domed diaphragm L is used to open and close communication between the first orifice I and the valve cavity H to thus open and close flow between the two orifices I and J as is known. When the diaphragm L is pushed downward (as viewed in FIGS. 1A and 1B) into contact with the valve seat K, the valve is closed. An actuator assembly M is used to control the position of the diaphragm L. The actuator assemble M may be pneumatic, hydraulic, manual or electromechanical. The actuator system M typically includes an actuator stem (not shown) that pushes on a button N in a central region of the diaphragm L. The diaphragm L typically is clamped about its periphery against the valve body E by a bonnet P to form a body seal to prevent leakage. The bonnet P is secured to the valve body E by a bonnet nut R. The diaphragm L may be plastic or metal, and the valve seat may be plastic or metal depending on the specific application of the valve A.

Referring to FIG. 2, flow capacity through the valve from inlet to outlet is largely influenced by the flow gap S that exists between the domed diaphragm L and the valve seat K. FIG. 2 illustrates in simplified schematic form this flow gap S. Increasing the gap S between the diaphragm L and the seat K will generally increase the flow capacity of the valve A.

In the prior art example of FIG. 2, the diaphragm is a multi-layered diaphragm (i.e.—an upper diaphragm U is disposed over a lower diaphragm V), and is a generally hemispherical dome that has a slightly flattened profile (due to manufacturing processes rather than by design). This diaphragm L is also supported in the open position by a diaphragm backing surface T, which deforms the diaphragm L and results in a flatter profile. The surface T may be formed as part of the bonnet P. In the open position illustrated in FIG. 2, the multi-layer diaphragm L is subjected to stress (in the regions indicated by the lines AA) due to its generally hemispherical slightly flattened profile interfering with the diaphragm backing surface T. The rated cycle life of the diaphragm L is a function of not only the geometry, but also wear caused by direct contact with the diaphragm backing surface T. The wear can also be caused in part by the diaphragm L rubbing against the backing surface T (e.g. micro-abrasions). Such wear is cause when fluid pressure in the open position pushing the diaphragm L against the surface T and button N.

### SUMMARY OF THE INVENTION

The invention is generally directed towards diaphragms and diaphragm valves with geometries that decrease stress and wear on diaphragms and increase the cycle life of diaphragms. Stresses and wear can be decreased by reducing the amount of diaphragm deflection or by reducing or eliminating contact between two diaphragms or a diaphragm and valve components.

One embodiment of the invention is a diaphragm for sealing an orifice of a valve that includes a bonnet. The diaphragm includes a diaphragm peripheral mounting portion and a sealing portion. The sealing portion includes an inner portion having a contour defined by a first radius and an outer portion having a contour defined by a second radius and extending from the diaphragm peripheral mounting portion to the inner portion. The first radius and the second radius are selected to prevent an interference with the bonnet.

Another embodiment of the invention is a diaphragm assembly for sealing an orifice of a valve. The diaphragm assembly includes a first diaphragm and a second diaphragm. The first diaphragm includes a first diaphragm peripheral mounting portion and a first diaphragm deflectable portion extending inward of the first diaphragm peripheral mounting portion. The first diaphragm deflectable portion includes a first concave surface, having a first radius, and a first convex surface. The second diaphragm is disposed over the first diaphragm. The second diaphragm includes a second diaphragm peripheral mounting portion and a second diaphragm deflectable portion extending inward from the second diaphragm peripheral mounting portion. The second deflectable portion includes a second concave surface, having a second radius, and a second convex surface. The second radius is greater than the first radius when the first and second diaphragms are in a non-deformed state.

Another embodiment of the invention is a diaphragm assembly for sealing an orifice of a valve that includes a first diaphragm and a second diaphragm. The first diaphragm includes a first diaphragm peripheral mounting portion and a first diaphragm deflectable portion extending inward from the first diaphragm peripheral mounting portion. The second diaphragm is disposed over the first diaphragm and includes a second diaphragm peripheral mounting portion and a second diaphragm deflectable portion. The second deflection portion includes an inner portion having a contour defined by a first radius and an outer portion having a contour defined by an second radius and extending from the second diaphragm peripheral mounting portion to the inner portion. The first radius is different than the second radius.

### BRIEF DESCRIPTION OF THE DRAWINGS

FIG. 1A is a cross-sectional view of a prior art valve;

FIG. 1B is an enlarged cross-sectional view of a portion of the prior art valve, indicated by reference character B in FIG. 1A;

FIG. 2 is a cross-sectional view of a prior art multi-layered diaphragm assembled in a valve;

FIG. 3 is a cross-sectional view of a diaphragm assembled into a valve, showing the valve in an open position;

FIG. 4 is a cross-sectional view of a diaphragm assembled into a valve, showing the valve in a closed position;

FIG. 5 is a geometric illustration of a diaphragm cross-section;

FIG. 6 is a cross-sectional view of a diaphragm assembly with diaphragms of different dimensions; and

FIG. 7 is a cross-sectional view of a diaphragm assembly with diaphragms of different dimensions.

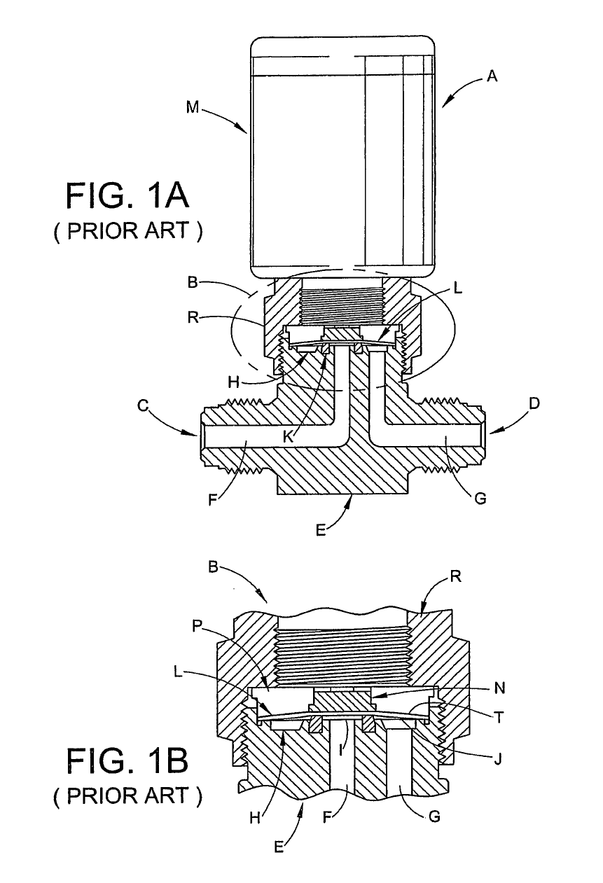

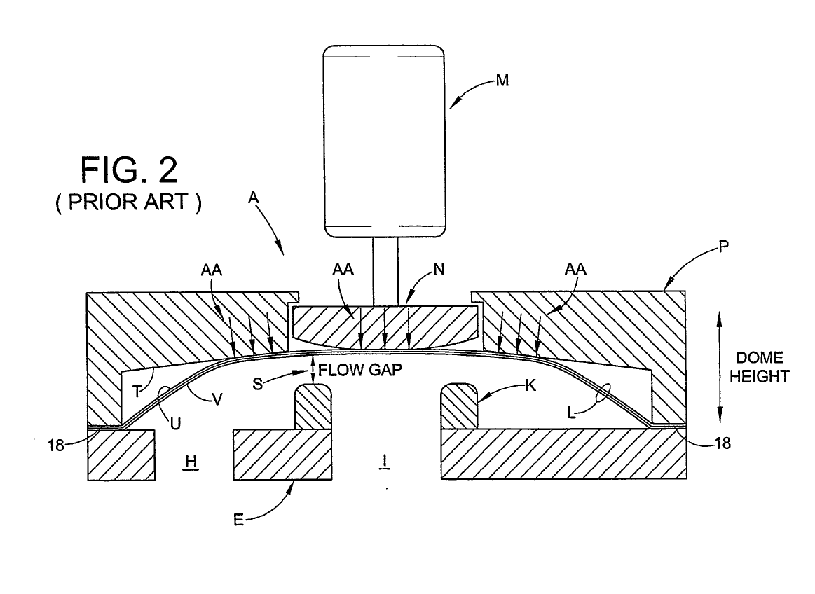

### DETAILED DESCRIPTION OF THE INVENTION

While the described embodiments herein are presented in the context of utilizing geometries to reduce stresses and wear of diaphragms deflected to open and close valves, those skilled in the art will readily appreciate that the present invention may be used in cooperation with many different diaphragm and valve configurations and with any system in which a diaphragm is repeatedly deflected, including but not limited in any manner to: diaphragms of complex material composition, such as diaphragms formed of multiple materials pressed or welded together; multilayered diaphragm assemblies or stacks that comprise numerous diaphragms, such as five or six; valves with metal or plastic valve seats; diaphragm pumps; and acoustic devices which modulate a diaphragm to create sound. These examples are intended to illustrate the broad application of the invention for utilizing geometry to reduce stresses and wear in diaphragms. The specific design and operation of the diaphragm valves provides no limitation on the present invention except as otherwise expressly noted herein.

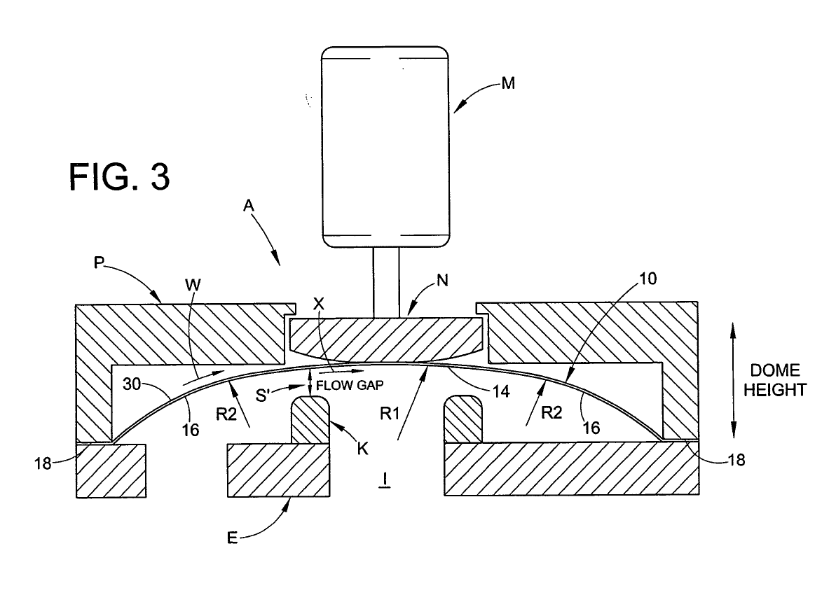

One embodiment of a diaphragm 10 is illustrated in FIGS. 3 and 4. FIG. 3 shows the diaphragm 10 assembled in a valve A in an open position. FIG. 4 shows the diaphragm 10 in the valve A in a closed position. The diaphragm 10 is a single diaphragm. The diaphragm 10 includes a mounting portion 18 and a sealing portion 30. When the valve A is in the open position the diaphragm 10 is in a free or relaxed state. In the free or relaxed state, the actuator system is not actively working to close the valve A and the shape of the sealing portion 30 of the diaphragm 10 is in a natural state. In the free and relaxed state, the sealing portion 30 is not hemispherical with a single radius of curvature, but rather has a variable radius of curvature with at least two different radii of curvature. The sealing portion includes an inner portion 14 and an outer portion 16. The inner portion 14 is defined by a first radius of curvature R1 and the outer portion 16 is defined by a second radius of curvature R2. The sealing portion 30 can be deflected to seal an orifice I in the valve A. The mounting portion 18 is disposed around the periphery of the sealing portion 30. Although the sealing portion 30 is described as having first and second radii of curvature R1, R2, in practice, the sealing portion 30 may have a complex set of radii of curvature. For example, the outer portion 16 may be defined by multiple radii and deviate from a hemispheric contour. Moreover, near the clamped periphery the radii of curvature may becomes quite varied. The inner portion 14 can also have an equally complex set of radii defining its contour. Thus, as to the sealing portion 30, the radii of curvatures of the inner and outer portions 14, 16 may be defined as an average radius of curvature as opposed to a single radius of curvature, particularly in the region close to the clamped periphery. In the exemplary embodiment, the average radius of the inner portion 14 is different than the average radius of the outer portion 16.

In accordance with an aspect of the invention, a radius of the inner portion 14 or the outer portion 16, varies by location on the inner portion 14 or outer portion 16. Referring to FIG. 3, the radii defining the outer portion increase as the distance away from (direction indicated by arrow W) the diaphragm mounting portion 18 increases. The radii defining the inner portion increase as the distance away from (direction indicated by arrow X) the outer portion 16 increases.

In the exemplary embodiment, the diaphragm 10 is configured to avoid or minimize contact with the bonnet P when in the relaxed or free state of FIG. 3. By increasing the average radius of the inner portion 14, the inner portion is flattened and the profile and dome height of the diaphragm 10 are lowered. The diaphragm 10 in FIG. 3, with a flattened inner portion 14, avoids the contact or interference with the bonnet P that is seen in FIG. 2, where the diaphragm L has a conventional profile. In addition to avoiding contact with the bonnet P when the diaphragm 10 is in a free and relaxed state, the lower profile and dome height allow the sealing portion 30 to experience some movement or expansion, due to pressure from fluid flow through the valve in the open position, and avoid or minimize interference or contact with the bonnet P.

In accordance with an aspect of the invention, the radius of curvature R1 is significantly greater than the radius of curvature R2, so that the inner portion 14 of the diaphragm 10 is significantly flattened as viewed in profile. Such a flattening of the diaphragm 10 maintains a substantial flow gap S′, but with significantly reduced stress in the deflected diaphragm 10, as shown in FIG. 4. In conventional diaphragms, large flow gaps require greater diaphragm deflection to achieve valve closure. As the necessary deflection increases, the stress on the diaphragm material also increases. The magnitude of the stress experienced by the diaphragm with each valve cycle (on/off cycle) has a significant influence on the cyclic lifetime of the diaphragm, with greater stress leading to fewer cycles and thus a lower rated cycle life. The flattened profile resulting from a radius of curvature R1 significantly greater than the radius of curvature R2 provides for less diaphragm deflection to achieve valve closure, which leads to reduced stress in the diaphragm 10 and a longer cycle life as compared to traditional diaphragms.

As described above, the radius of curvature R1 of the inner portion 14 and the radius of curvature R2 of the outer portion 16 can be selected in a manner that avoids or minimizes interference between the diaphragm 10 and the bonnet P. For example, the radius of curvature R1 of the inner portion 16 may be at least two (2) times as great as the radius of curvature R2 of the outer portion 14, and particularly about twice as great as the average radius of curvature near the diaphragm periphery. The general appearance of the diaphragm is that of a dome with the inner portion significantly flattened, which provides an increased flow gap at a given dome height and reduced diaphragm stress at a given deflection. When the inner portion 14 radius of curvature R1 is at least twice the outer portion 16 radius of curvature P2 the bonnet P does not interfere with the diaphragm when the valve A is in an open position and the diaphragm 10 is in a relaxed or free state. An example of such an embodiment is a diaphragm with an inner portion 14 radius of curvature R1 equal to 4.718 inches and an outer portion 16 radius of curvature R2 equal to 1.978 inches. This example produces a dome height of 0.0290 inches. A conventional diaphragm with a single radius of curvature equal to 2.356 inches produces a dome height of 0.0340 inches.

Selecting radii to avoid or minimize contact between the diaphragm 10 and the bonnet P can also be achieved by R1 to R2 ratios that are less than 2 to 1. In addition, R2 can be larger than R1. Increasing the radius of either the inner portion 14 or the outer portion 16 will reduce the dome height of the diaphragm 10 and reduce the likelihood of the diaphragm 10 interfering with the bonnet P. In another aspect of this embodiment, either R1 or R2 can approach infinity, which would produce an inner or outer portion that is substantially flat. An inner portion 14 radius of curvature R1 approaching infinity produces a substantially flat inner portion 14, resulting in a lower dome height than conventional diaphragms.

FIG. 3 shows the actuator system M in contact with the diaphragm 10, through the button N, in the free or relaxed state. In this state, the button N merely “sits” on the diaphragm 10 under the force of gravity, as the button is loosely retained within the bonnet. Thus, there are no large stresses applied to the diaphragm 10 by the actuator system M when the diaphragm 10 is in a free or relaxed state.

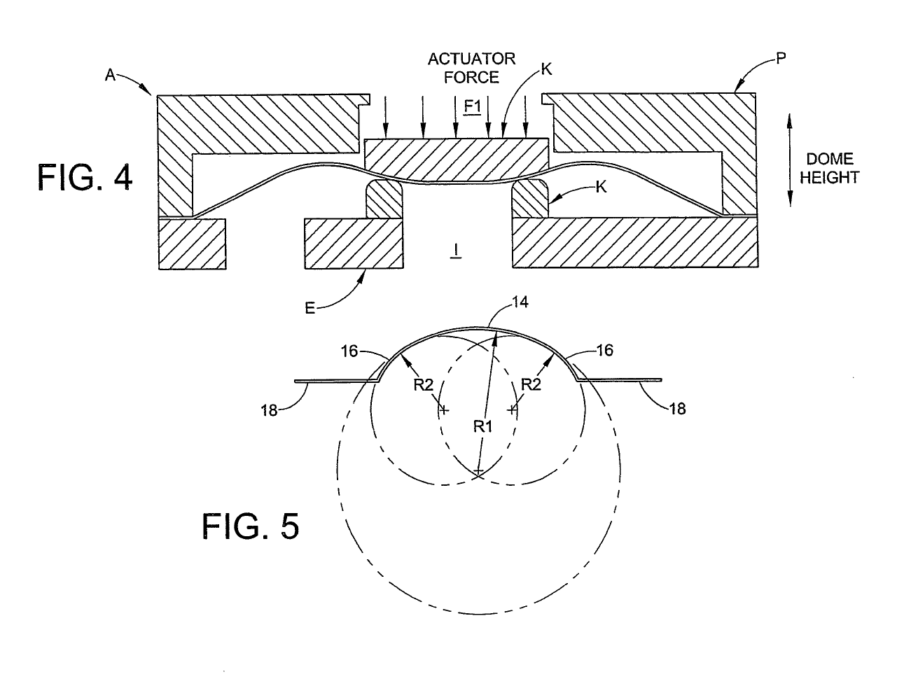

FIG. 4 illustrates the diaphragm 10 deflected into the closed position by the actuator system exerting a force F1 on the diaphragm 10 though the button N. FIG. 5 illustrates geometrically how the flattened profile is provided by an inner portion 14 radius of curvature R1 that is about twice the radius of curvature R2 of outer portions 16 of the diaphragm 10. As is shown in FIG. 5, the contour of the inner portion 14 is generally defined by the radius of curvature R1 and the outer portion 16 is generally defined by the radius of curvature R2.

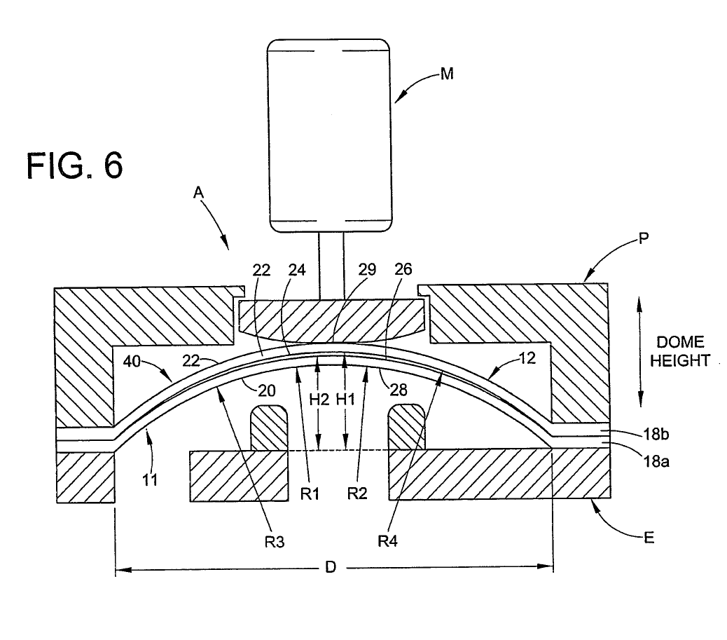

One embodiment of a diaphragm assembly or diaphragm stack 40 is illustrated in FIG. 6. The diaphragm assembly 40 is shown in cross-section and includes two diaphragms 11, 12. The diaphragm assembly 40 can be used in place of the single diaphragm 10 used in the valve A illustrated in FIGS. 3 and 4.

In the example of FIG. 6, the diaphragm assembly 40 includes a lower diaphragm 11 and an upper diaphragm 12, with the upper diaphragm 12 overlaying or disposed over the lower diaphragm 11. The illustrated diaphragms 11, 12 each include an outer peripheral mounting portion 18A, 18B respectively. The peripheral mounting portions 18A, 18B are sealingly clamped between the valve body E and the bonnet P. The diaphragms 11, 12 thus provide a body seal for the valve assembly. The diaphragms 11, 12 also include deflectable portions 20, 22 that extend inward from the outer peripheral mounting portions 18A, 18B respectively. The deflectable portions 20, 22 are generally, although not exclusively, arcuate or dome shaped. The deflectable portion 20 of the lower diaphragm 11 includes a concave surface 28, with a radius of curvature R3, and a convex surface 26 with a dome height H2. The deflectable portion 22 of the upper diaphragm 12 includes a concave surface 24, with a radius of curvature R4, an inner dome height Hi, and a convex surface 29.

Conventionally, diaphragms that comprise multi-layer diaphragms are manufactured to have substantially the same dimensions and geometry. When such conventional diaphragms are assembled as a multi-layered diaphragm into a valve, the upper diaphragm is forced over the lower diaphragm with an end result of both diaphragms undergoing deformation. This deformation causes stresses in both diaphragms. In addition, this deformation results in the lower surface of the upper diaphragm being forced into contact with the upper surface of the lower diaphragm. This contact causes additional wear as the upper and lower diaphragms rub against each other as the multi-layered diaphragm is moved into position to close or open the valve. Elimination or reduction of the stresses due to deforming diaphragms during assembly and the elimination or reduction of wear due to diaphragms rubbing against one another when the valve is opened and closed can lengthen the cycle life of multi-layered diaphragms.

In accordance with the embodiment illustrated in FIG. 6, the two diaphragms 11, 12 do not have the same dimensions and geometry. The upper diaphragm 12 is generally larger than the lower diaphragm 11. This allows the upper diaphragm 12 to be disposed over the lower diaphragm 11 with either an elimination of dimensional interference or a lessening of demensional interference. Either the elimination of interference or a lessening of interference will have the result of lessening the stress on the diaphragms 11, 12 when the diaphragms 11, 12 are assembled into a diaphragm assembly 40, as compared to conventional diaphragms assemblies.

The diaphragms 11, 12 have generally congruent outer diameters D and closely overlay each other along their peripheries. The inner dome height Hi, arc length, and surface area of the lower surface 24 of the upper diaphragm 12 are about equal to or greater than the dome height H2, arc length, and surface area of the upper surface 26 of the lower diaphragm 11. These dimensional relationships improve the nesting or stacking of the two diaphragms 11, 12 and reduce interference, as compared to conventional diaphragms. The reduced interference lessens the deformation of the diaphragms 11, 12 in the diaphragm assembly 40, thus reducing the stress as well as wear.

In the embodiment illustrated by FIG. 6, the upper diaphragm 12 is larger than the lower diaphragm 11 when comparing the concave surfaces 28, 24 of the diaphragms 11, 12. Configuring radius R4 to be larger than radius R3 improves the nesting or stacking of the diaphragms 11, 12. In an exemplary embodiment, the radius R4 defining the concave surface 24 of the upper diaphragm 12 is larger than the radius R3 defining the concave surface 28 of the lower diaphragm 11, where the radii R3, R4 are measured prior to disposing the upper diaphragm 12 over the lower diaphragm 11, when the diaphragms 11, 12 are in a non-deformed state. A radius R4 that is larger than radius R3 results in a surface area of the concave surface 24 of the upper diaphragm 12 that is larger than the surface area of the concave surface 28 of the lower diaphragm 11.

In one embodiment the difference in the geometry and dimensions of the diaphragms 11, 12 is large enough to create a gap between the upper 12 and lower 11 diaphragms when the diaphragms 11, 12 are assembled. In another embodiment the difference in the geometry and dimensions are small enough to allow the diaphragms 11, 12 to touch along the lower surface 24 of the upper diaphragm 12 and the upper surface 26 of the lower diaphragm 11. Provided there are differences that make the upper diaphragm 12 larger than the lower diaphragm 11 in the non-deformed state, the stresses on the diaphragms 11, 12, once they are assembled, will be less than the stresses on assembled diaphragms that are substantially similar in geometry and dimensions.

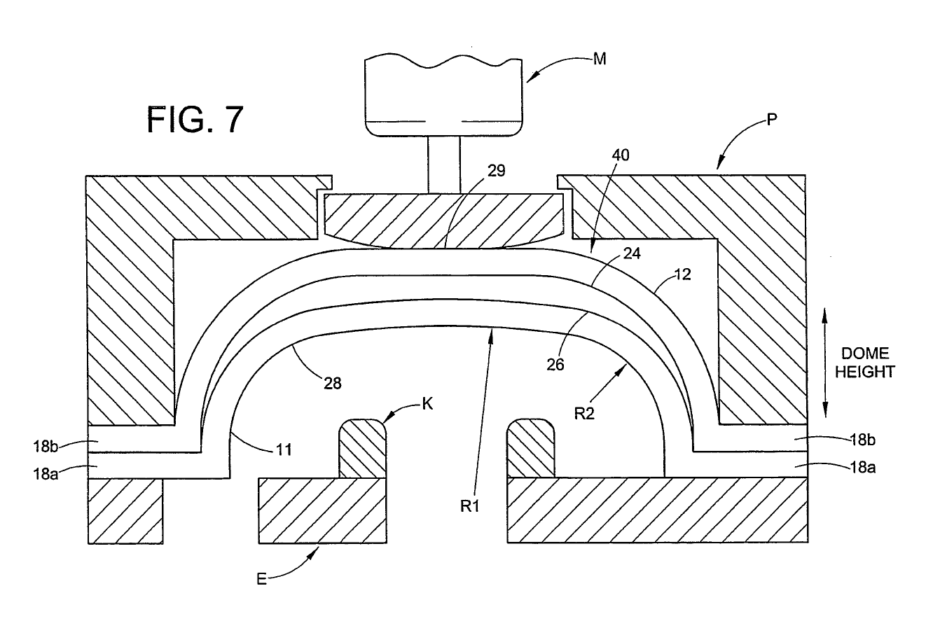

In the example of FIG. 6 the diaphragms 11, 12 have a general dome or arcuate shape. The example of FIG. 7 illustrates diaphragms with more complex geometries, of the type shown in FIGS. 3 and 5. If the dimension of an upper diaphragm make the upper diaphragm larger than the lower diaphragm, diaphragms of any geometry are more easily assembled or stacked and are subject to less stress when assembled. Referring to FIG. 7, the surface area of the inner surface 24 of the upper diaphragm 12 is larger than the surface area of the inner surface 28 of the lower diaphragm 11. This allows the diaphragms 11, 12 to be dimensioned in a manner to allow a gap between the upper and lower diaphragms 11, 12 or allows the inner surface 24 of the upper diaphragm to be in contact with the outer surface 26 of the lower diaphragm and still result in lower stresses on the assembled diaphragms 11, 12 than if the diaphragms 11, 12 were substantially similar in dimensions.

Additional aspects of the invention directed to a multi-layered assembled diaphragm of different dimensions are: utilizing diaphragms of different thicknesses within the same assembly; utilizing diaphragms made of different material within the same assembly; and placing lubricant between the upper and lower diaphragms. Diaphragms of differing thicknesses or differing materials may offer different resistances to forces. Such forces may be applied to diaphragms by the actuator system or from the pressure of fluid flowing through the valve. Combining diaphragms of different thicknesses or materials allows for greater flexibility in providing the proper resistance to such forces in valves that serve different purposes. Examples of materials that may be used for manufacturing diaphragms are elgiloy, hastelloy, MP35N alloy, and 316 stainless steel. Placing lubricant between the upper and lower diaphragms in a multi-layer diaphragm assembly can reduce stresses and wear on the diaphragms. As a diaphragm assembly is deflected to seal a valve, the upper diaphragm may rub against the lower diaphragm. A lubricant may reduce the stresses and wear experience by the diaphragms by reducing the coefficient of friction between the upper and lower diaphragms. Examples of lubricants that may be applied to diaphragms are krytox, polytetrafluoroethylene (PTFE), and tungsten disulphide (WS₂).

While various aspects of the invention are described and illustrated herein as embodied in combination in the exemplary embodiments, these various aspects may be realized in many alternative embodiments, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however, such values and ranges are not to be construed in a limiting sense and are intended to be critical values or ranges only if so expressly stated.

1. A diaphragm for sealing an orifice of a valve that includes a bonnet, the diaphragm comprising:
a. a diaphragm peripheral mounting portion, and
b. a sealing portion, the sealing portion comprising:
i. an inner portion having a contour defined by a first radius, and
ii. an outer portion having a contour defined a second radius and extending from the diaphragm peripheral mounting portion to the inner portion; wherein the first radius and the second radius are selected to prevent an interference with the bonnet.

2. The diaphragm of claim 1, wherein the first radius is greater than the second radius.

3. The diaphragm of claim 2, wherein the first radius is at least twice as large as the second radius.

4. The diaphragm of claim 1, wherein the second radius is greater than the first radius.

5. The diaphragm of claim 1, wherein the first radius is infinite.

6. The diaphragm of claim 1, wherein the second radius is infinite.

7. A valve comprising:
a. a valve body, the valve body comprising an inlet, an outlet, and a flow path extending from the inlet to the outlet;
b. a bonnet;
c. a diaphragm, the diaphragm comprising:
i. a diaphragm peripheral mounting portion clamped between the valve body and the bonnet; and
ii. a sealing portion, the sealing portion comprising:
1. an inner portion having a contour defined by a first radius, and
2. an outer portion having a contour defined by a second radius and extending from the diaphragm peripheral mounting portion to the inner portion, wherein the first radius and the second radius are selected to prevent an interfere with the bonnet; and
d. an actuator system to deflect the diaphragm to seal the inlet.

8. The valve in claims 7, wherein the first radius is infinite.

9. The valve of claim 7, wherein the second radius is infinite.

10. The valve of claim 7, wherein the actuator system is movable between a sealing position, where the sealing portion is deflected by the actuator to stop flow through the flow path, and an open position, where the sealing portion allows flow through the flow channel.

11. The valve of claim 10, wherein when the actuator system is in the open position, the actuator system does not apply force upon the sealing portion of the diaphragm beyond a force generated from the weight of the actuator and gravity.

12. A diaphragm for sealing an orifice of a valve, the diaphragm comprising:
a. a diaphragm peripheral mounting portion, and
b. a sealing portion, the sealing portion comprising:
i. an inner portion having a first average radius; and
ii. an outer portion having a second average radius and extending from the diaphragm peripheral mounting portion to the inner portion;
wherein the first average radius and the second average radius are selected to prevent an interference with the bonnet.

13. A diaphragm for sealing an orifice of a valve, the diaphragm comprising:
a. a diaphragm peripheral mounting portion; and
b. a sealing portion, the sealing portion comprising:
i. an inner portion; and
ii. an outer portion extending from the diaphragm peripheral mounting portion to the inner portion;
wherein radii that define the inner portion increase as a distance from the outer portion increases.

14. The diaphragm of claim 13, wherein radii that define the outer portion increase as a distance from the diaphragm mounting portion increases.

15. A diaphragm assembly for sealing an orifice of a valve, the diaphragm assembly comprising:
a. a first diaphragm comprising:
i. a first diaphragm peripheral mounting portion, and
ii. a first diaphragm deflectable portion extending inward of the first diaphragm peripheral mounting portion, the first diaphragm deflectable portion comprising a first concave surface, having a first radius, and a first convex surface; and
b. a second diaphragm disposed over the first diaphragm, the second diaphragm comprising:
i. a second diaphragm peripheral mounting portion, and
ii. a second diaphragm deflectable portion extending inward from the second diaphragm peripheral mounting portion, the second diaphragm deflectable portion comprising a second concave surface, having a second radius, and a second convex surface;
wherein the second radius is greater than the first radius when the first and second diaphragms are in a non-deformed state.

16. The diaphragm assembly of claim 15, wherein a surface area of the second concave surface is greater than a surface area of the first concave surface, when the first and second diaphragms are in a non-deformed state.

17. The diaphragm assembly of claim 15, wherein the first diaphragm has a thickness that is greater than the second diaphragm.

18. The diaphragm assembly of claim 15, wherein the second diaphragm has a thickness that is greater than the first diaphragm.

19. The diaphragm assembly of claim 15, wherein the first diaphragm is made of a different material than the second diaphragm

20. The diaphragm assembly of claim 15, wherein a lubricant is placed on the first convex surface.

21. The diaphragm assembly of claim 15, wherein a lubricant is placed on the second concave surface.

22. A valve comprising:
a. a valve body, the valve body comprising an inlet, an outlet, and a flow path extending from the inlet to the outlet;
b. a bonnet;
c. a diaphragm assembly, the diaphragm assembly comprising:
i. a first diaphragm, the first diaphragm comprising:
1. a first diaphragm peripheral mounting portion, clamped between the valve body and the bonnet; and
2. a first deflectable portion extending inward from the first diaphragm peripheral mounting portion, the first deflectable portion comprising a first concave surface having a first radius and a first convex surface; and
ii. a second diaphragm disposed over the first diaphragm, the second diaphragm comprising:
1. a second diaphragm peripheral mounting portion, clamped between the valve body and the bonnet and in contact with the first diaphragm peripheral mounting portion; and
2. a second deflectable portion extending inward from the second diaphragm peripheral mounting portion, the second deflectable portion comprising a second concave surface having a second radius and a second convex surface, wherein the second radius is greater than the first radius when the first and second diaphragms are in a non-deformed state; and
d. an actuator to deflect the first and second diaphragm to seal the inlet.

23. The valve of claim 22, wherein a surface area of the second concave surface is greater than a surface area of the first concave surface, when the first and second diaphragms are in a non-deformed state.

24. The valve of claim 22, wherein a thickness of the first diaphragm is different than the thickness of the second diaphragm.

25. The valve of claim 22, wherein the first diaphragm is made of a different material than the second diaphragm.

26. The valve of claim 22, wherein a lubricant is placed on the first convex surface.

27. The valve of claim 22, wherein a lubricant is placed on the second concave surface.

28. A diaphragm assembly for sealing an orifice in a valve, the diaphragm assembly comprising:
a. a first diaphragm comprising:
i. a first diaphragm peripheral mounting portion comprising a mounting surface and a diaphragm supporting surface; and
ii. a first deflectable portion extending inward from the first diaphragm peripheral mounting portion, the first deflectable portion comprising a first inner surface and a first outer surface; and
b. a second diaphragm disposed over the first diaphragm, the second diaphragm comprising:
i. a second diaphragm peripheral mounting portion, in contact with the diaphragm supporting surface of the first diaphragm peripheral mounting portion; and
ii. a second deflectable portion extending inward from the second diaphragm peripheral mounting portion, the second deflectable portion comprising a second inner surface and a second outer surface;
wherein a maximum distance from a plane defined by the mounting surface to the second inner surface is greater than the maximum distance from the plane to the first outer surface.

29. The diaphragm assembly of claim 28, wherein a surface area of the second inner surface is greater than a surface area of the first inner surface when the first and second diaphragms are in a non-deformed state

30. The diaphragm assembly of claim 28, wherein a thickness of the first diaphragm is different than a thickness of the second diaphragm.

31. The diaphragm assembly of claim 28, wherein the first diaphragm is made of a different material than the second diaphragm.

32. The diaphragm assembly of claim 28, wherein a lubricant is placed on first outer surface.

33. The diaphragm assembly of claim 28, wherein a lubricant is placed on the second inner surface.

34. A valve comprising:
a. a valve body, the valve body comprising an inlet, an outlet, and a flow path extending from the inlet to the outlet;
b. a bonnet;
c. a diaphragm assembly, the diaphragm assembly comprising:
i. a first diaphragm comprising:
1. a first diaphragm peripheral mounting portion, comprising a mounting surface and a diaphragm supporting surface, clamped between the valve body and the bonnet; and
2. a first deflectable portion extending inward from the first diaphragm peripheral mounting portion, the first deflectable portion comprising a first inner surface and a first outer surface; and
ii. a second diaphragm disposed over the first diaphragm, the second diaphragm comprising:
1. a second diaphragm peripheral mounting portion, clamped between the valve body and the bonnet and in contact with the diaphragm supporting surface of the first diaphragm peripheral mounting portion; and
2. a second deflectable portion extending inward from the second diaphragm peripheral mounting portion, the second deflectable portion comprising a second inner surface and a second outer surface, wherein a maximum distance from a plane defined by the mounting surface to the second inner surface is greater than the maximum distance from the plane to the first outer surface; and
d. an actuator to deflect the first and the second diaphragms to seal the inlet.

35. The valve of claim 34, wherein a surface area of the first inner surface is greater than the surface area of the second inner surface when the first and the second diaphragms are in a non-deformed state.

36. The valve of claim 34, wherein a thickness of the first diaphragm is different than a thickness of the second diaphragm.

37. The valve of claim 34, wherein the first diaphragm is made of a different material than the second diaphragm.

38. The valve of claim 34, wherein a lubricant is placed on the first outer surface.

39. The valve of claim 34, wherein a lubricant is placed on the second inner surface.

40. A diaphragm assembly for sealing an orifice of a valve comprising:
a. a first diaphragm that includes a first mounting portion and a first deflecting portion;
b. a second diaphragm that includes a second mounting portion disposed over the first mounting portion and a second deflectable portion disposed over the first deflectable portion, wherein the portions are contoured such that there is no interference between the first deflectable portion and the second deflectable portion when the second deflectable portion is disposed over the first deflectable portion.

41. The diaphragm assembly of claim 40, wherein the first diaphragm has a thickness different than a thickness of the second diaphragm.

42. The diaphragm assembly of claim 40, wherein the first diaphragm is made of a different material than the second diaphragm.

43. The diaphragm assembly of claim 40, wherein a lubricant is placed on a surface of the first deflectable portion proximate to the second deflectable portion.

44. The diaphragm assembly of claim 40, wherein a lubricant is placed on a surface of the second deflectable portion proximate to the first deflectable portion.

45. A diaphragm assembly for sealing an orifice of a valve, the diaphragm assembly comprising:
a. a first diaphragm comprising:
i. a first diaphragm peripheral mounting portion, and
ii. a first diaphragm deflectable portion extending inward from the first diaphragm peripheral mounting portion;
b. a second diaphragm disposed over the first diaphragm and comprising:
i. a second diaphragm peripheral mounting portion,
ii. a second diaphragm deflectable portion, the second deflectable portion comprising:
1. an inner portion having a contour defined by a first radius, and
2. an outer portion having a contour defined by an second radius and extending from the second diaphragm peripheral mounting portion to the inner portion;
wherein the first radius is different than the second radius.

46. The diaphragm assembly of claim 45, wherein the first deflectable portion comprising a first inner surface and the second deflectable portion comprising a second inner surface; and further wherein a surface area of the second inner surface is greater than a surface area of the first inner surface, when the first and second diaphragms are in a non-deformed state.

47. The diaphragm assembly of claim 45, wherein the second diaphragm is such that there is no interference caused by the depositing of the second diaphragm over the first diaphragm.

48. The diaphragm assembly of claim 45, wherein the first diaphragm is made of a different material than the second diaphragm.

49. The diaphragm assembly of claim 45, wherein the first diaphragm has a thickness different than a thickness of the second diaphragm.

50. The diaphragm assembly of claim 46 wherein a lubricant is placed on the second inner surface.

51. The diaphragm assembly of claim 45 wherein the first deflection portion comprising an outer surface, and further wherein a lubricant is placed on the outer surface.

52. A valve comprising a. a valve body, the valve body comprising an inlet, an outlet, and a flow path extending from the inlet to the outlet;
b. a bonnet;
c. a diaphragm assembly, the diaphragm assembly comprising:
i. a first diaphragm comprising:
1. a first diaphragm peripheral mounting portion, clamped between the valve body and the bonnet; and
2. a first deflectable portion extending inward from the first diaphragm peripheral mounting surface; and
ii. a second diaphragm disposed over the first diaphragm and comprising:
1. a second diaphragm peripheral mounting portion, clamped between the valve body and the bonnet and in contact with the first diaphragm peripheral mounting portion; and
2. a second deflectable portion, the second deflectable portion comprising:
(a) an inner portion having a contour defined by a first radius, and
(b) an outer portion having a contour defined by a second radius and extending from the second diaphragm peripheral mounting portion to the inner portion, wherein the first radius is different than the second radius; and
d. an actuator to deflect the first and the second diaphragm to seal the inlet.

53. The valve of claim 52, wherein the first deflectable portion comprising a first inner surface and the second deflectable portion comprising a second inner surface; and further wherein a surface area of the second inner surface is greater than a surface area of the first inner surface when the first and second diaphragms are in a non-deformed state.

54. The valve of claim 52, wherein the second diaphragm is such that there is no interference caused by depositing the second diaphragm over the first diaphragm.

55. The valve of claim 52, wherein the first diaphragm is made of a different material than the second diaphragm.

56. The valve of claim 52, wherein the first diaphragm has a thickness different than a thickness of the second diaphragm.

57. The valve of claim 53 wherein a lubricant is placed on the second inner surface.

58. The valve of claim 52 wherein the first deflection portion comprising an outer surface, wherein a lubricant is placed on the outer surface.

59. A method of assembling a valve assembly comprising:
a. forming a diaphragm with a sealing area, the diaphragm includes a first portion with a first arcuate profile and a second portion with a second arcuate profile; wherein the first arcuate profile is different from the second arcuate profile;
b. securing the diaphragm into a valve by clamping the diaphragm between a valve body and a bonnet.

60. A method of assembling a valve assembly comprising:
a. forming a first diaphragm;
b. forming a second diaphragm that is larger than the first diaphragm;
c. depositing the second diaphragm over the first diaphragm;
d. securing the first and second diaphragm to a valve housing by clamping the first and second diaphragm between a valve body and a bonnet.
